(19) United States
(12) Patent Application Publication
(10) Pub. No.: US 2022/0258725 A1
(43) Pub. Date: Aug. 18, 2022

(54) CONTROL DEVICE AND VEHICLE

(71) Applicant: HONDA MOTOR CO., LTD., Tokyo (JP)

(72) Inventors: Hiroshi Tagami, Tokyo (JP); Masahiro Takeuchi, Tokyo (JP); Yasuharu Kawarasaki, Tokyo (JP); Kohei Hanada, Tokyo (JP)

(21) Appl. No.: 17/674,050

(22) Filed: Feb. 17, 2022

(30) Foreign Application Priority Data
Feb. 18, 2021 (JP) 2021-024033

(51) Int. Cl. B60W 20/50; B60W 50/02; B60W 10/06

(52) U.S. Cl. CPC B60W 20/50; B60W 50/0205; B60W 2510/0619; B60W 2510/0676; B60W 2710/0666; B60W 10/06

(57) ABSTRACT

Provided is a control device for a vehicle, the vehicle including an internal combustion engine, a generator capable of being rotated by the internal combustion engine, and a motor that outputs a driving force to a drive wheel by using power generated by the generator, in which the control device detects a failure of the internal combustion engine when the control device has instructed the internal combustion engine and the generator to generate power and the generator is performing power driving.

### CROSS-REFERENCE TO RELATED APPLICATION

Priority is claimed on Japanese Patent Application No. 2021-024033, filed Feb. 18, 2021, the content of which is incorporated herein by reference.

### BACKGROUND

### Field of the Invention

The present invention relates to a control device and a vehicle.

### Description of Related Art

A technology of detecting malfunctions of an engine of a vehicle is known. For example, Published Japanese Translation No. 2015-505761 of the PCT International Publication discloses a technology of rotating an engine by adding a torque thereto without starting the engine, and detecting malfunctions of the engine on the basis of a fuel pressure at that time.

### SUMMARY

The technology disclosed in Published Japanese Translation No. 2015-505761 of the PCT International Publication is a technology of detecting malfunctions of an engine when a vehicle is operating in an EV mode. However, in a conventional technology, there are some cases in which the malfunctions of an engine cannot be detected when a vehicle is operating in a non-EV mode. Furthermore, in the conventional technology, there are some cases in which malfunctions such as gas shortage cannot be detected when an engine is driving at a low torque.

The present invention has been made in view of such circumstances, and an object thereof is to provide a control device and a vehicle that can detect malfunctions of an engine even when the vehicle is operating in the non-EV mode or when the engine is driving at a low torque.

A control device and a vehicle according to the present invention have adopted the following configuration.

(1): A control device according to one aspect of the present invention is a control device for a vehicle, the vehicle including an internal combustion engine, a generator capable of being rotated by the internal combustion engine, and a motor that outputs a driving force to a drive wheel by using power generated by the generator, in which the control device detects a failure of the internal combustion engine when the control device has instructed the internal combustion engine and the generator to generate power and the generator is performing power driving.

(2): In the aspect of (1) described above, the control device detects that a failure has occurred in the internal combustion engine when a state in which the control device has instructed the internal combustion engine and the generator to generate power and the generator is performing power driving has continued for a predetermined period.

(3): In the aspect of (1) described above, when the internal combustion engine is in a state of a low water temperature before being warmed up, the internal combustion engine performs a low-torque driving of lowering the output torque as compared to the output torque after being warmed up, and the control device stops detecting a failure of the internal combustion engine during the low-torque driving.

(4): In the aspect of (3) described above, the control device determines whether an air-to-fuel ratio of the internal combustion engine is equal to or greater than a first threshold value on the basis of a value output by an air-to-fuel ratio sensor included in the vehicle while the internal combustion engine is performing the low-torque driving, and stops the low-torque driving when it is determined that the air-to-fuel ratio of the internal combustion engine is equal to or greater than the first threshold value.

(5): In the aspect of (3) described above, the control device determines whether a pressure sensor value of a fuel pipe in the internal combustion engine is equal to or less than a second threshold value on the basis of a value output by a pressure sensor included in the vehicle while the internal combustion engine performs the low-torque driving, and stops the low-torque driving when it is determined that the pressure sensor value is equal to or less than the second threshold value.

(6): A vehicle according to another aspect of the present invention is a vehicle including an internal combustion engine, a generator capable of being rotated by the internal combustion engine, a motor that outputs a driving force to a drive wheel by using power generated by the generator, and a control device, in which the control device detects a failure of the internal combustion engine when the control device has instructed the internal combustion engine and the generator to generate power and the generator is performing power driving.

According to (1) to (5), it is possible to detect malfunctions of the engine even when the vehicle is operating at a non-EV mode or when the engine is driving at a low torque.

According to (3) to (4), it is possible to detect a torque failure of the engine without incurring additional costs.

### BRIEF DESCRIPTION OF THE DRAWINGS

FIG. 1 is a diagram which shows an example of a configuration of a vehicle M according to the present embodiment.

FIG. 2 is a diagram which shows an example of a functional configuration of a control device.

FIG. 3 is a diagram which shows an example of an output of each component of the vehicle M when a torque failure has occurred in an engine.

FIG. 4 is a diagram which shows an example of a relationship between a torque of an engine and a torque of a first motor.

FIG. 5 is a flowchart which shows an example of a flow of operation performed by a control device.

### DESCRIPTION OF EMBODIMENTS

Hereinafter, an embodiment of a control device and a vehicle according to the present invention will be described with reference to the drawings.

[Overall Configuration]

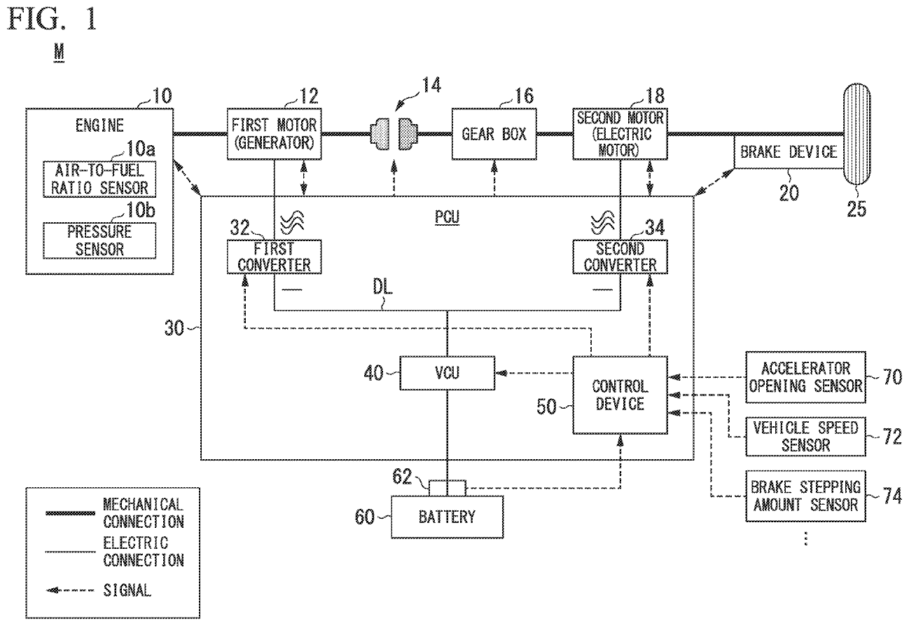

FIG. 1 is a diagram which shows an example of a configuration of the vehicle M of the present embodiment. The vehicle M having the configuration shown in FIG. 1 is a hybrid vehicle capable of switching between a series method and a parallel method. The series method is a method in which an engine and a drive wheel are not mechanically connected, power of the engine is used exclusively for power generation by a generator, and generated electric power is supplied to an electric motor for traveling. The parallel method is a method in which the engine and the drive wheel can be mechanically connected (or via a fluid such as a torque converter), and the power of the engine can be transmitted to the drive wheel or used for power generation. The vehicle M having the configuration shown in FIG. 1 can switch between the series method and the parallel method by connecting or disconnecting a lockup clutch 14.

As shown in FIG. 1, the vehicle M is equipped with, for example, an engine 10, a first motor (generator) 12, a lockup clutch 14, a gearbox 16, a second motor (electric motor) 18, a brake device 20, and a drive wheel 25, a power control unit (PCU) 30, a battery 60, a battery sensor 62 such as a voltage sensor, a current sensor, or a temperature sensor, and vehicle sensors such as an accelerator opening sensor 70, a vehicle speed sensor 72, and a brake depression amount sensor 74. This vehicle M includes at least the engine 10, the second motor 18, and the battery 60 as drive sources.

The engine 10 is an internal combustion engine that outputs power by burning fuel such as gasoline. The engine 10 is a reciprocating engine including, for example, a combustion chamber, a cylinder and a piston, an intake valve, an exhaust valve, a fuel injection device, an ignition plug, a connecting rod, and a crank shaft. In addition, the engine 10 may be a rotary engine. The engine 10 further includes an air-to-fuel ratio sensor 10a that detects an air-to-fuel ratio (A/F) of gas in the combustion chamber, and a pressure sensor 10b that detects a pressure in fuel pipes of the engine 10.

The first motor 12 is, for example, a three-phase AC generator. The first motor 12 has a rotor connected to an output shaft (for example, a crank shaft) of the engine 10, and generates power by using power output by the engine 10. The output shaft of the engine 10 and the rotor of the first motor 12 are connected to a side of the drive wheel 25 via the lockup clutch 14.

The lockup clutch 14 switches between a state in which the output shaft of the engine 10 and the rotor of the first motor 12 are connected to a side of the drive wheel 25 and a state in which the output shaft and the rotor are disconnected from the side of the drive wheel 25, in response to an instruction from the PCU 30.

The gearbox 16 is a transmission. The gearbox 16 shifts the power output by the engine 10 and transmits it to the side of the drive wheel 25. A gear ratio of the gearbox 16 is designated by the PCU 30.

The second motor 18 is, for example, a three-phase AC electric motor. A rotor of the second motor 18 is connected to the drive wheel 25. The second motor 18 outputs power to the drive wheel 25 using the supplied electric power. Moreover, the second motor 18 generates power by using a kinetic energy of the vehicle M when the vehicle M decelerates, and stores the generated electric power in the battery 60 via a second converter 34 and a VCU 40, which will be described below.

The brake device 20 includes, for example, a brake caliper, a cylinder that transmits a hydraulic pressure to the brake caliper, and an electric motor that causes the cylinder to generate a hydraulic pressure. The brake device 20 may include a mechanism for transmitting a hydraulic pressure generated by an operation of a brake pedal to the cylinder via a master cylinder as a backup. The brake device 20 is not limited to the configuration described above, and may be an electronically controlled hydraulic brake device that transmits a hydraulic pressure of the master cylinder to the cylinder.

The PCU 30 includes, for example, a first converter 32, a second converter 34, a voltage control unit (VCU) 40, and a control device 50. It is only an example that these components are combined into a single-structure configuration as the PCU 30, and these components may be disposed in a distributed manner.

The first converter 32 and the second converter 34 are, for example, AC to DC converters. DC side terminals of the first converter 32 and the second converter 34 are connected to a DC link DL. The battery 60 is connected to the DC link DL via the VCU 40. The first converter 32 converts an alternating current generated by the first motor 12 into a direct current and outputs it to the DC link DL, or converts the direct current supplied via the DC link DL into an alternating current and supplies it to the first motor 12. Similarly, the second converter 34 converts an alternating current generated by the second motor 18 into a direct current and outputs it to the DC link DL, or converts the direct current supplied via the DC link DL into an alternating current and supplies it to the second motor 18.

The VCU 40 is, for example, a DC-DC converter. The VCU 40 boosts electric power supplied from the battery 60 and outputs the boosted electric power to the DC link DL.

A function of the control device 50 will be described below. The battery 60 is, for example, a secondary battery such as a lithium-ion battery.

The accelerator opening sensor 70 is attached to an accelerator pedal, which is an example of an operator that receives an acceleration instruction from a driver, detects the amount of operation of the accelerator pedal, and outputs the amount to the control device 50 as an accelerator opening. The vehicle speed sensor 72 includes, for example, a wheel speed sensor attached to each wheel and a speed calculator, integrates wheel speeds detected by the wheel speed sensor to derive a speed (a vehicle speed) of the vehicle M, and outputs the speed to the control device 50. The brake depression amount sensor 74 is attached to a brake pedal, which is an example of an operator that receives a deceleration or stop instruction by the driver, detects the amount of operation of the brake pedal, and outputs the amount to the control device 50 as a brake depression amount.

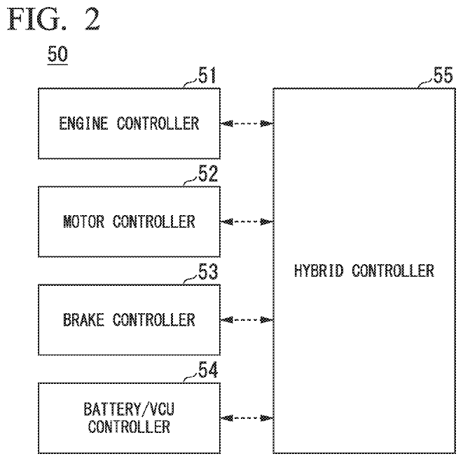

FIG. 2 is a diagram which shows an example of a functional configuration of the control device 50. The control device 50 includes, for example, an engine control unit 51, a motor control unit 52, a brake control unit 53, a battery/VCU control unit 54, and a hybrid control unit 55. These components are realized by, for example, a hardware processor such as a central processing unit (CPU) executing a program (software). In addition, some or all of these components may be realized by hardware (circuit units; including circuitry) such as large scale integration (LSI), an application specific integrated circuit (ASIC), a field-programmable gate array (FPGA), and a graphics processing unit (GPU), and may also be realized by software and hardware in cooperation.

In addition, each of the engine control unit 51, the motor control unit 52, the brake control unit 53, and the battery/VCU control unit 54 may be replaced with a control device separate from the hybrid control unit 55, for example, a control device such as an engine electronic control unit (ECU), a motor ECU, a brake ECU, or a battery ECU.

The engine control unit 51 performs ignition control, throttle opening control, fuel injection control, fuel cut control, and the like of the engine 10 in response to an instruction from the hybrid control unit 55. For example, the engine control unit 51 receives a command value regarding the number of rotations and torque of the engine 10 from the hybrid control unit 55, and performs control such that the engine 10 is operated according to the command value. The engine control unit 51 further transmits values acquired by the air-to-fuel ratio sensor 10a and the pressure sensor 10b of the engine 10 to the hybrid control unit 55.

The motor control unit 52 performs switching control of the first converter 32 and/or the second converter 34 in response to an instruction from the hybrid control unit 55.

The brake control unit 53 controls the brake device 20 in response to an instruction from the hybrid control unit 55.

The battery/VCU control unit 54 calculates a state of charge (SOC) of the battery 60 on the basis of an output of the battery sensor 62 attached to the battery 60, and outputs it to the hybrid control unit 55. In addition, the battery/VCU control unit 54 operates the VCU 40 in response to an instruction from the hybrid control unit 55 and raises a voltage of the DC link DL.

The hybrid control unit 55 determines a traveling mode on the basis of outputs of the accelerator opening sensor 70, the vehicle speed sensor 72, and the brake depression amount sensor 74, and outputs an instruction to the engine control unit 51, the motor control unit 52, the brake control unit 53, and the battery/VCU control unit 54 according to the traveling mode. Furthermore, the hybrid control unit 55 determines a command value regarding the number of rotations and torque of the engine 10 in each traveling mode, and transmits the determined command value to the engine control unit 51. The hybrid control unit 55 further performs torque failure detection processing of the engine 10 to be described below on the basis of the values of the air-to-fuel ratio sensor 10a and the pressure sensor 10b transmitted from the engine control unit 51.

[Various Types of Traveling Modes]

The traveling mode determined by the hybrid control unit 55 will be described below. The traveling mode includes the following modes.

(1) Series Hybrid Traveling Mode (ECVT) In a series hybrid traveling mode, the hybrid control unit 55 makes the lockup clutch 14 disconnected, supplies fuel to the engine 10 to operate it, and supplies electric power generated by the first motor 12 to the battery 60 and the second motor 18. Then, the second motor 18 is driven by using the electric power supplied from the first motor 12 or the battery 60, and the vehicle M is caused to travel using power from the second motor 18. The series hybrid traveling mode is an example of a mode in which an internal combustion engine is operating while the internal combustion engine and a drive wheel are not mechanically connected.

(2) EV Traveling Mode (EV)

In an EV traveling mode, the hybrid control unit 55 makes the lockup clutch 14 disconnected, drives the second motor 18 using the electric power supplied from the battery 60, and causes the vehicle M to travel using the power from the second motor 18.

(3) Engine Drive Traveling Mode (LU)

In an engine drive traveling mode, the hybrid control unit 55 makes the lockup clutch 14 disconnected, consumes fuel to operate the engine 10, and transmits at least a part of the power output by the engine 10 to the drive wheel 25 to cause the vehicle M to travel. At this time, the first motor 12 may or may not generate power.

(4) Regeneration

At a time of regeneration, the hybrid control unit 55 makes the lockup clutch 14 disconnected and causes the second motor 18 to generate power using the kinetic energy of the vehicle M. The generated electric power at the time of regeneration is stored in the battery 60 or is discarded by a waste power operation.

[Outline of Operation Performed by the Control Device 50]

Next, an outline of the operation performed by the control device 50 will be described. Unless otherwise specified, an operation of the control device 50 described below is assumed to be executed while the vehicle M is traveling in an ECVT mode.

When the vehicle M is traveling in the ECVT mode, that is, when the first motor 12 is caused to generate power by a torque output by the engine 10, the engine 10 may be in a state (hereinafter, referred to as a “torque failure” in some cases) in which it cannot output the torque due to a lack of gas, a failure, or the like.

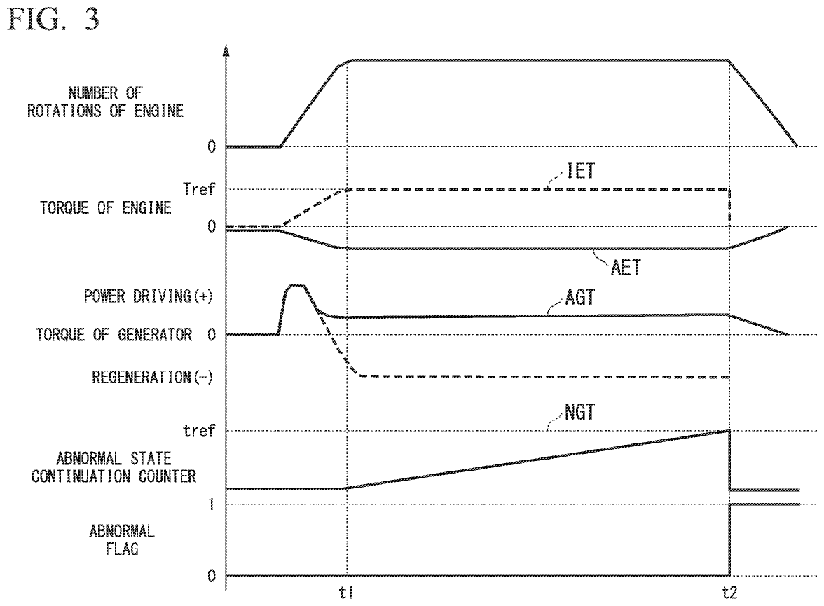

FIG. 3 is a diagram which shows an example of an output of each component of the vehicle M when a torque failure occurs in the engine 10. In FIG. 3, IET indicates an instruction torque to the engine 10, AET indicates an actual torque of the engine 10, AGT indicates an actual torque of the first motor 12, and NGT indicates a torque of the first motor 12 when the engine 10 is normal. As shown in FIG. 3, when no torque failures have occurred in the engine 10, the torque of the engine 10 takes a value of the instruction torque IET, and the torque of the first motor 12 takes a value of the normal torque NGT, accordingly. That is, the first motor 12 executes power generation and performs a regenerative operation according to a torque output by the engine 10. However, when there is a torque failure occurring in the engine 10, the engine 10 can output only the torque AET lower than the instruction torque IET, and the first motor 12 performs power driving of outputting the torque AGT larger than the normal torque NGT to make up for a torque deficiency.

Therefore, the control device 50 instructs the engine 10 to output the torque, that is, instructs the engine 10 and the first motor 12 to generate power, and detects the torque failure of the engine 10 when the first motor 12 is executing the power driving. More specifically, the control device 50 instructs the engine 10 and the first motor 12 to generate power, and detects that a failure has occurred in the torque of the engine 10 when a state in which the first motor 12 is executing the power driving has continued for a predetermined period.

Referring to FIG. 3, since the instruction torque IET of the engine 10 is equal to or greater than a reference value Tref, and the first motor 12 is in a state of executing power driving at a time t1, the control device 50 detects the torque failure of the engine 10 and starts to measure a duration time of the state. After that, the control device 50 detects that a failure has occurred in the torque of the engine 10 by determining that the state has continued for a predetermined period tref or more at time t2. AS a result, malfunctions of the engine can be detected even when the vehicle is operating in a non-EV mode.

In the description described above, the control device 50 detects the torque failure of the engine 10 at a timepoint when the instruction torque IET of the engine 10 is equal to or greater than a predetermined value Tref. That is, when it is less than the predetermined value Tref even if the instruction torque IET is positive, the control device 50 does not detect the torque failure of the engine 10. This is because when the instruction torque IET is less than the predetermined value Tref, it is assumed that the engine 10 performs a low-torque driving regardless of the presence or absence of a failure, and the accuracy of the detection method described above is low. Examples of a scene where the engine 10 performs a low-torque driving include a scene where the engine 10 is in a state of a low-water temperature before the engine 10 is warmed up. At this time, the engine 10 performs a low-torque driving in which the output torque is lowered as compared to that after the engine 10 is warmed up.

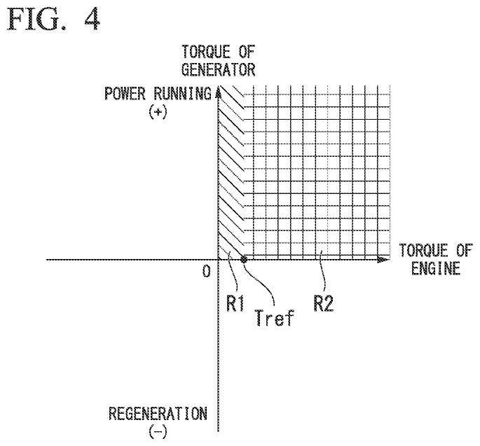

FIG. 4 is a diagram which shows an example of a relationship between the torque of the engine 10 and the torque of the first motor 12. In FIG. 4, a diagonal area R1 indicates a low-torque area of the engine 10, and an area R2 indicates a non-low torque area of the engine 10. The control device 50 detects the torque failure of the engine 10 when a combination of the instruction torque IET of the engine 10 and the torque of the first motor 12 is in the non-low torque area R2.

On the other hand, when the combination of the instruction torque IET of the engine 10 and the torque of the first motor 12 is in the low torque area R1, or when a combination of an actual torque of the engine 10 and the torque of the first motor 12 is in the low torque area R1, the control device 50 determines whether the air-to-fuel ratio of the engine 10 is equal to or greater than the first threshold value on the basis of a value output by the air-to-fuel ratio sensor 10a, and detects that the torque of the engine 10 has failed when it is determined that the air-to-fuel ratio is equal to or greater than the first threshold value. The control device 50 furthermore determines whether a pressure sensor value of the fuel pipe in the engine 10 is equal to or less than the second threshold value on the basis of a value output by the pressure sensor 10b, and determines that the torque of the engine 10 has failed when it is determined that the pressure sensor value is equal to or less than the second threshold value. These conditions are effective conditions for determining a gas shortage or failure during a low-torque driving of the engine 10. By determining the torque failure of the engine 10 on the basis of these conditions, it is possible to detect the torque failure of the engine 10 even when the engine 10 is driving at a low torque. The control device 50 stops the low-torque driving and protects the engine 10 when the torque failure of the engine 10 is detected while the engine 10 is driving at a low torque.

[Flow of Operation Performed by the Control Device 50]

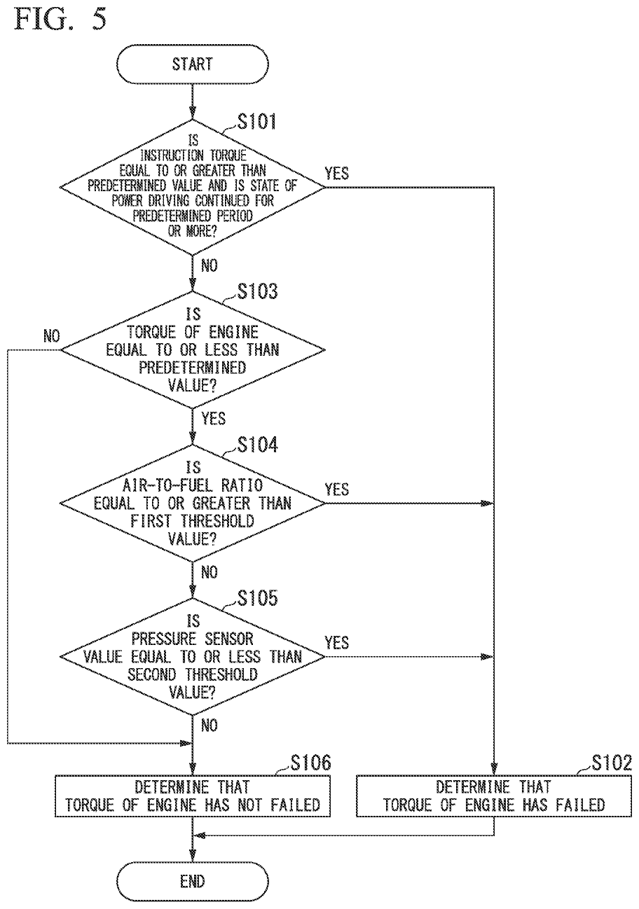

Next, a flow of the operation of the control device 50 will be described with reference to FIG. 5. FIG. 5 is a flowchart which shows an example of the flow of the operation of the control device 50. Processing of this flowchart is executed for each predetermined control cycle during driving of the vehicle M.

First, the control device 50 determines whether the instruction torque IET to the engine 10 is equal to or greater than the predetermined value Tref, and the state in which the first motor 12 is executing the power driving has continued for the predetermined period tref or more (step S101). When it is determined that the instruction torque IET to the engine 10 is equal to or greater than the predetermined value Tref and the state in which the first motor 12 is executing the power driving has continued for the predetermined period tref or more, the control device 50 determines that the torque of the engine 10 has failed (step S102).

On the other hand, when it is determined that the instruction torque IET to the engine 10 is equal to or greater than the predetermined value Tref and the state in which the first motor 12 is executing the power driving has not continued for the predetermined period tref or more, the control device 50 determines whether the torque output by the enginel0 is equal to or less than the predetermined value Tref (step S103). When it is determined that the torque output by the engine 10 is not equal to or less than the predetermined value Tref, the control device 50 determines that the torque of the engine 10 has not failed (step S104).

On the other hand, when it is determined that the torque output by the engine 10 is equal to or less than the predetermined value Tref, the control device 50 determines whether an air-to-fuel ratio output by the air-to-fuel ratio sensor l0a is equal to or greater than the first threshold value (step S105). When it is determined that the air-to-fuel ratio output by the air-to-fuel ratio sensor l0a is equal to or greater than the first threshold value, the control device 50 determines that the air-to-fuel ratio is in a lean state, and the torque of the engine 10 has failed.

On the other hand, when it is determined that the air-to-fuel ratio output by the air-to-fuel ratio sensor l0a is less than the first threshold value, the control device 50 determines whether a pressure sensor value output by the pressure sensor 10b is equal to or less than the second threshold value (step S106). When it is determined that the pressure sensor value output by the pressure sensor 10b is equal to or less than the second threshold value, the control device 50 determines that the torque of the engine 10 has failed.

On the other hand, when it is determined that the pressure sensor value output by the pressure sensor 10b is greater than the second threshold value, the control device 50 determines that the torque of the engine 10 has not failed. As a result, processing of this flowchart ends.

According to the processing of the present embodiment described above, the control device 50 detects the torque failure of the engine 10 on the basis of a driving situation of the first motor 12 when the vehicle M is traveling in the ECVT mode and the instruction torque to the engine 10 is equal to or greater than a predetermined value, and detects the torque failure of the engine 10 on the basis of values output by the air-to-fuel ratio sensor 10a and the pressure sensor 10b when the engine 10 is driving at a low torque. As a result, malfunctions of the engine can be detected even when the vehicle is operating in the non-EV mode or when the engine is driving at a low torque.

Although a form for carrying out the present invention has been described above using the embodiment, the present invention is not limited to the embodiment, and various modifications and substitutions can be made within a range not departing from the gist of the present invention.

What is claimed is:

1. A control device for a vehicle, the vehicle including an internal combustion engine, a generator capable of being rotated by the internal combustion engine, and a motor that outputs a driving force to a drive wheel by using power generated by the generator,
wherein the control device detects a failure of the internal combustion engine when the control device has instructed the internal combustion engine and the generator to generate power and the generator is performing power driving.

2. The control device according to claim 1, wherein the control device detects that a failure has occurred in the internal combustion engine when a state in which the control device has instructed the internal combustion engine and the generator to generate power and the generator is performing power driving has continued for a predetermined period.

3. The control device according to claim 1,
wherein, when the internal combustion engine is in a state of a low water temperature before being warmed up, the internal combustion engine performs a low-torque driving of lowering the output torque as compared to the output torque after being warmed up, and
wherein the control device stops detecting a failure of the internal combustion engine during the low-torque driving.

4. The control device according to claim 3,
wherein, the control device determines whether an air-to-fuel ratio of the internal combustion engine is equal to or greater than a first threshold value on the basis of a value output by an air-to-fuel ratio sensor included in the vehicle while the internal combustion engine is performing the low-torque driving, and stops the low-torque driving when it is determined that the air-to-fuel ratio of the internal combustion engine is equal to or greater than the first threshold value.

5. The control device according to claim 3, wherein, the control device determines whether a pressure sensor value of a fuel pipe in the internal combustion engine is equal to or less than a second threshold value on the basis of a value output by a pressure sensor included in the vehicle while the internal combustion engine performs the low-torque driving, and stops the low-torque driving when it is determined that the pressure sensor value is equal to or less than the second threshold value.

6. A vehicle comprising an internal combustion engine, a generator capable of being rotated by the internal combustion engine, a motor that outputs a driving force to a drive wheel by using power generated by the generator, and a control device,
wherein the control device detects a failure of the internal combustion engine when the control device has instructed the internal combustion engine and the generator to generate power and the generator is performing power driving.
